(19) United States
(12) Patent Application Publication
(10) Pub. No.: US 2014/0173231 A1
(43) Pub. Date: Jun. 19, 2014

(54) SEMICONDUCTOR MEMORY DEVICE AND SYSTEM OPERATING METHOD

(71) Applicant: SK hynix Inc., Gyeonggi-do (KR)

(72) Inventors: Myung-Suk LEE, Gyeonggi-do (KR); Jeong-Soon KWAK, Gyeonggi-do (KR); Eui-Jin KIM, Gyeonggi-do (KR); Gi-Pyo UM, Gyeonggi-do (KR)

(73) Assignee: SK hynix Inc., Gyeonggi-do (KR)

(21) Appl. No.: 13/968,116

(22) Filed: Aug. 15, 2013

(30) Foreign Application Priority Data
Dec. 13, 2012 (KR) 10-2012-0145332

(51) Int. Cl. G06F 3/06

(52) U.S. Cl. CPC G06F 3/065; G06F 3/0614; G06F 3/0679
USPC 711/162

(57) ABSTRACT

Disclosed is a semiconductor memory device for controlling a memory block. The semiconductor memory device includes a plurality of memory blocks to store data, and controller. The memory controller requests a first memory block, of the plurality of memory blocks, to performing a copy operation to copy the first memory block to a second memory block of the plurality of memory blocks. The controller then requests the first memory block to perform an operation different than the copy operation. The controller then requests the memory block to stop the copy operation based on the to perform an operation different than the copy operation. Finally, the controller requests the memory block to resume the copy operation after the operation different than the copy operation is completed.

### CROSS-REFERENCE TO RELATED APPLICATIONS

The present application claims priority of Korean Patent Application No. 10-2012-0145332, filed on Dec. 13, 2012, which is incorporated herein by reference in its entirety.

### BACKGROUND

1. Field

Exemplary implementations of the present invention relate to a semiconductor design technology, and more particularly, to a semiconductor memory device controlling a memory block.

2. Description of the Related Art

Generally, a semiconductor memory device is classified into volatile memory devices such as a dynamic random access memory (DRAM) or a static random access memory (SRAM), and nonvolatile memory devices, such as a programmable read only memory (PROM), an erasable PROM (EPROM), an electrically EPROM (EEPROM), or a flash memory device. The most significant feature of the volatile memory device and the nonvolatile memory device is whether data stored in a memory cell are reserved after a predetermined time passes.

The determination as to whether the data is reserved may be based on a memory cell structure. For example, the volatile memory device and the nonvolatile memory device may have different memory cell structures. Therefore, data stored in the volatile memory device disappears after a predetermined time passes. In contrast, data stored in the nonvolatile memory device does not disappear even after a predetermined time passes. Therefore, in case of the volatile memory device, a refresh operation is essential to preserving data. However, in the case of the non-volatile memory device the refresh operation is not need to be performed. Since the refresh operation does not need to be performed, a nonvolatile may have lower power consumption and higher integration than a volatile memory device. Therefore, the nonvolatile memory device has been widely used as a storage medium in a portable device.

Among the nonvolatile memory devices, a flash memory device stores data in the memory cell by a programming operation and an erasing operation. During the programming operation, electrons accumulate in a floating gate of a transistor forming a memory cell. During the erasing operation, electrons accumulated in the floating gate of the transistor are discharged into a substrate. The flash memory device stores data of “1” or “0” in the memory cell by the programming operation and senses an amount of electrons accumulated in the floating gate at the time of the read operation, in order to determine whether the data stored in the memory cell is “1” data or “0” data. For reference, the flash memory device has a memory chip formed therein so as to store the data and the memory chip may be configured of a plurality of memory blocks.

### SUMMARY

An exemplary semiconductor memory may include semiconductor memory device, comprising a method of operating a semiconductor memory having a plurality of memory blocks, comprising performing a block copy operation in response to a request of a block copy operation; and stopping the block copy operation in response to a request of a specific operation while the block copy operation is performed.

A method of operating a semiconductor memory having a plurality of memory blocks, comprising performing a block copy operation which copies a data stored in a first memory block to a second memory block; stopping the block copy operation if a specific operation is requested while the block copy operation is performed; and performing the specific operation.

An exemplary semiconductor system may includes a host controller configured to transmit a block copy operation signal and a specific operation signal to a semiconductor memory device; and the semiconductor memory device configured to performs a block copy operation in response to the block copy operation signal and a specific operation in response to the specific operation signal from the host controller, wherein the semiconductor memory device, comprises: a plurality of memory blocks configured to store data according to the block copy operation and the specific operation; and a memory controller configured to perform the block copy operation in response to the block copy operation signal from the host controller; and configured to stop the block copy operation in response to the specific operation signal from the host controller while the block copy operation is performed

The semiconductor memory device in accordance with the implementation of the present invention perform specific operations in addition to the read and write operation within the block copy operation period for the defective memory blocks among the plurality of memory blocks, thereby reducing the latency time for the specific operations in addition to the read and write operations.

### BRIEF DESCRIPTION OF THE DRAWINGS

FIG. 1 is a block diagram illustrating an exemplary semiconductor memory device.

FIGS. 2A and 2B are diagrams schematically showing an operation of an exemplary circuit.

FIGS. 3A and 3B are diagrams for schematically showing an operation of an exemplary circuit operation.

FIG. 4 is a diagram showing an operation state of a block copy operation of the exemplary semiconductor memory device of FIG. 1.

### DETAILED DESCRIPTION

Hereinafter, exemplary implementations of the present invention will be described in detail with reference to the accompanying drawings so that those skilled in the art may easily practice the present invention.

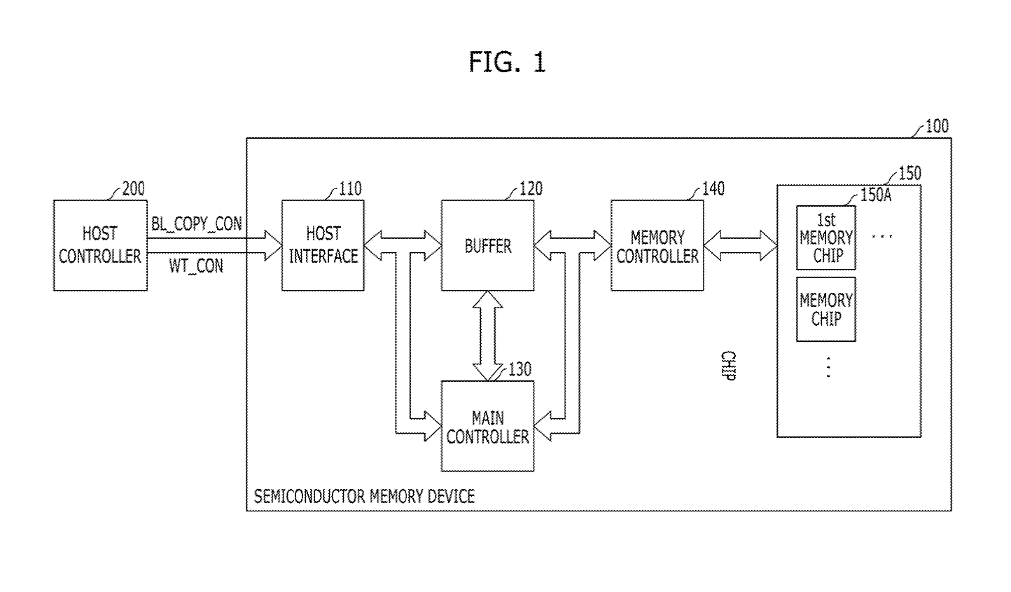

FIG. 1 is a block diagram illustrating an exemplary semiconductor memory device.

Referring to FIG. 1, the semiconductor memory device 100 includes a host interface 110, a buffer 120, a main controller 130, a memory controller 140, and a plurality memory chips 150.

The host interface 110 is a component for communicating and receiving signals between a host controller 200, such as a central processing unit (CPU) and the semiconductor memory device 100. The host interface 110 includes circuits for communicating and receiving a signal, such as a command signal, an address signal, or a data signal that is that communicated between the host controller 200 and the semiconductor memory device 100. The host interface 110 receives a block copy operation signal BL_COPY_CON and a specific operation signal WT_CON from the host controller 200. The buffer 120 buffers signals input/output through the host interface 110. Further, the main controller 130 controls signals communicated between the host interface 110 and the buffer 120 and between the buffer 120 and the memory controller 140. The main controller 140 further controls the plurality of memory chips 150 in response to the command signal input through the host interface 110. The memory controller 140 further controls specific operations in addition to the read and write operations of the plurality of memory chips 150. The memory controller 140 controls the plurality of memory chips 150 to perform specific operations, in addition to the read and write operations. In the configuration shown in FIG. 1, each memory chip 150 may include a plurality of memory blocks, each of which may include a plurality of pages, each of which performs the read and write operations.

The exemplary semiconductor memory device 100 performs a block copy operation by replacing defective memory blocks, from among the plurality of memory blocks, with normal memory blocks. In particular, the exemplary semiconductor memory device 100 performs specific operations, such as the read operation and the write operation while the block copy operation is performed. The block copy operation is not limited to the operation of replacing the defective memory blocks with the normal memory blocks. The block copy operation may include an operation of copying data from any memory block to another memory block. For example, the block copy operation includes wear leveling, garbage collection, and all the operations associated with replacing defective memory blocks.

If the memory block includes a plurality of pages, the exemplary semiconductor memory device 100 may perform the block copy operation with the page as a unit

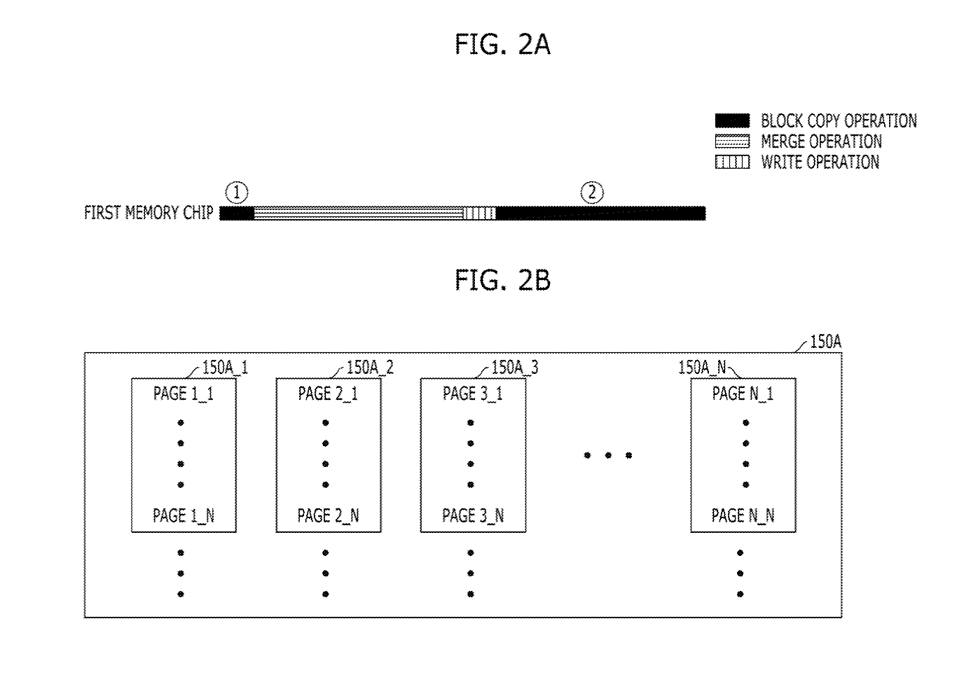

FIGS. 2A and 2B are diagrams schematically showing an operation of an exemplary circuit.

The first memory chip 150A included in the semiconductor memory device 100 comprises a plurality of memory blocks 150A_1, 150A_2 . . . 150A_N. Each of the plurality of memory blocks 150A_1, 150A_2 . . . 150A_N includes a plurality of pages PAGE1_{—}1 . . . PAGEN_N.

FIGS. 2A and 2B illustrates a case in which the semiconductor memory device 100 receives a request for a specific operation of a third memory blocks 150A_3, while a block copy operation is being performed in between the first memory blocks 150A_1 and the second memory blocks 150A_2.

The block copy operation between the first and second memory blocks 150A_1 and 150B_1 is a copy operation of copying a data stored in the first memory block 150A_1 to a second memory block 150B_1. The specific operation may include a merge operation, a read operation and a write operation.

Referring to FIGS. 2A and 2B, the memory controller 140 of the semiconductor memory device 100 performs a block copy operation \textcircled{1} which copies the data stored in the first memory block 150A_1 to the second memory block 150A_2 in response to the block copy operation signal BL_COPY_CON. If the specific operation signal WT_CON is received while the block copy operation \textcircled{1} is performed, the memory controller 140 temporarily stops the block copy operation \textcircled{1}.

At this time, the memory controller 140 stores memory information that is related to a progression state of the block copy operation. In particular, the memory information may include a page address of a memory block which the block copy operation is completed. For example, if the block copy operation\textcircled{1} is completed until a third page PAGE2_{—}3 of the second memory block 150A_2, the memory information includes the page address of the third page PAGE2_{—}3.

Then, the memory controller 140 performs the specific operation to the third memory blocks 150A_3 according to the specific operation signal WT_CON. The specific operations include operations except for the block copy operation, for example, the merge operation and write operation.

After the specific operation is completed, the memory controller 140 performs the remaining block copy operation \textcircled{2} to the second memory block 150A_2, referring to the stored memory information. The remaining block copy operation \textcircled{2} restarted from third page PAGE2_{—}3 of the second memory block 150A_2 corresponding to the stored memory information.

In other words, the semiconductor memory device 100 preferentially performs the specific operation over the block copy operation, and then performs the remaining block copy operation \textcircled{2} after the specific operation is completed. This means that the exemplary semiconductor memory device 100 may perform specific operations in addition to the merge operation and the write operation while the block copy operation is performed.

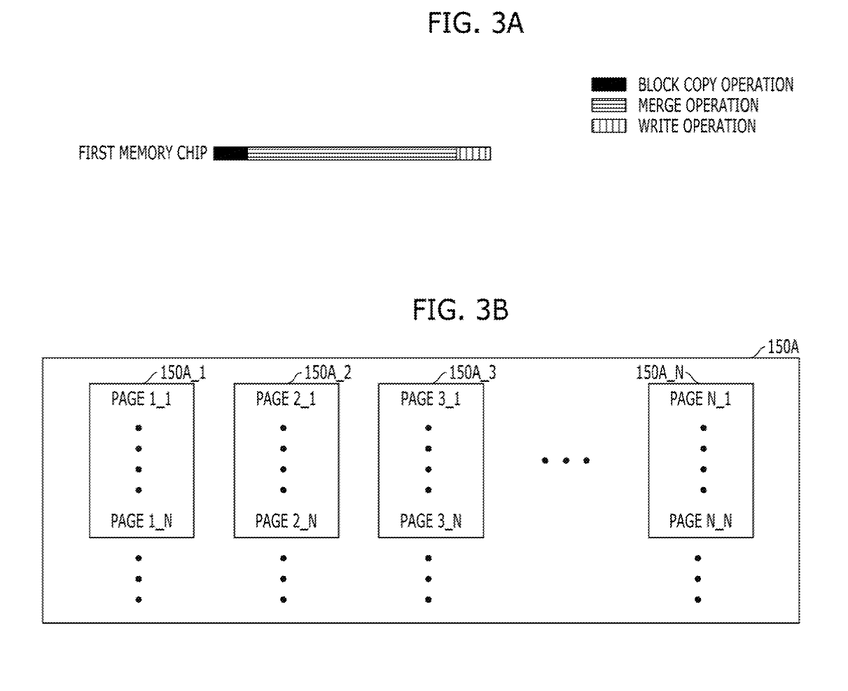

FIGS. 3A and 3B are diagrams schematically showing an operation of an exemplary circuit operation. FIGS. 3A and 3B illustrates a case in which a same memory block receives a request for a specific operation while a block copy operation is being performed in the memory block.

In particular, FIGS. 3A and 3B illustrates a case in which the semiconductor memory device 100 receives a request for a specific operation of the first memory blocks 150A_1 or the second memory blocks 150A_2, while the block copy operation is being performed from the first memory blocks 150A_1 to the second memory blocks 150B_1 of the first memory chip 150A. The specific operation includes a merge operation and a write operation. The specific operation does not include a read operation.

Referring to FIGS. 3A and 3B, the memory controller 140 of the semiconductor memory device 100 performs a block copy operation \textcircled{1} which copies a data stored in the first memory block 150A_1 to the second memory block 150A_2 in response to the block copy operation signal BL_COPY_CON. If the specific operation signal WT_CON of the first memory blocks 150A_1 is received from the host controller 200 while the block copy operation\textcircled{1} is performed, the memory controller 140 stops the block copy operation\textcircled{1} and performs the specific operation of the first memory blocks 150A_1. At this time, the memory controller 140 does stores the memory information that is related to a progression state of the block copy operation.

Also, after the specific operation of the first memory blocks 150A_1 are completed, the memory controller 140 does not perform the remaining block copy operation \textcircled{2} to the second memory block 150A_2.

Since the data in the first memory blocks 150A_1_is newly updated by the specific operation of the first memory blocks 150A_1, the memory controller 140 does not perform the remaining block copy operation \textcircled{2} corresponding to the old data prior to the updating.

At this time, if the specific operation of the first memory blocks 150A_1 is a read operation, the memory controller 140 performs the operation the illustrated in FIGS. 2A to 2B. Since the read operation of the first memory blocks 150A_1 does not have effect on changing of the data stored on the first memory blocks 150A_1, the data stored on the first memory blocks 150A_1 is not old data.

Meanwhile, as illustrated in FIGS. 2A to 2B and 3A to 3B, in order for the memory block to perform the block copy operation, the temporary stop operation, and the resume operation, a buffer memory, for example, in the memory controller 140 (see FIG. 1) needs to store the memory information. That is, in order to perform the block copy on a memory block and then perform the block copy on the memory block in the temporarily stopped state, the buffer memory included in the memory controller 140 needs to have the memory information corresponding to the block copy operation and the memory information corresponding to the temporary stop operation. In other words, the semiconductor memory device 100 includes a database for storing the memory information. The database may be included in the memory controller 140. For reference, when the block copy operation is completed, the database having the memory information may provide, to a corresponding controller, to perform a next block copy operation.

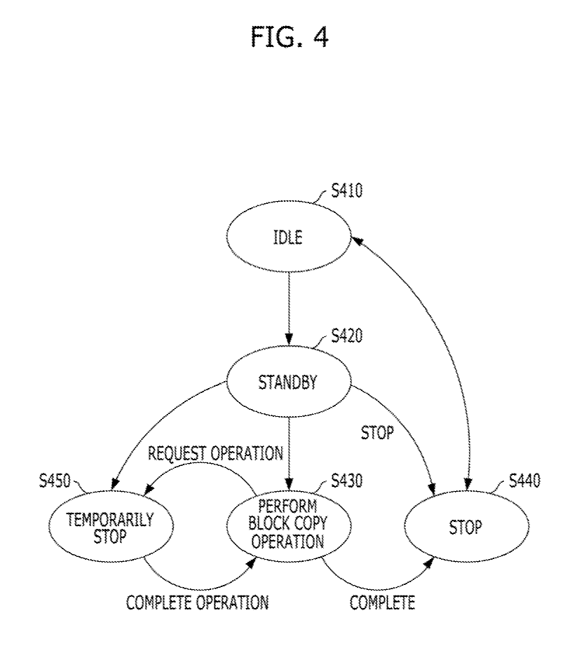

FIG. 4 is diagram showing an operation state of a block copy operation of the exemplary semiconductor memory device of FIG.

FIG. 4 illustrates an idle state S410, a standby state S420, a block copy progressing state S430, a stop state S440, and a temporary stop state S450.

The idle state S410 is a state without the block copy request. The standby state S420 is a state in which information regarding a memory block on which a block copy operation will be performed based on a block copy request is stored in the defined database. Block copy progressing state S430 is a state in which the block copy operation is performed according to the block copy request requested in the standby state S420. When the block copy operation is completed in block copy progressing state S430, the block copy operation stops in the stop state S440. After the stop state S440, the process returns to the idle state S410.

The temporary stop state S450 is a state of temporarily stopping the block copy operation. When operations other than the block copy operation (found in the standby state S420 and the block copy progressing state S430 states are requested, the operation state becomes the temporary stop state S450. When the specific operations have been completed, the block copy operation performed in the block copy progressing state S430 is resumed. In this case, the database in which the memory information is stored supplies the memory information of memory block subjected to the block copy operation, in advance, to the corresponding controller. For reference, when operations other than the block copy operation are performed on the same memory block, even though the block copy operation is not completed as in FIGS. 3A and 3B, the operation state may be the stop state S440.

As described above, the exemplary semiconductor memory device 100 temporarily stops a block copy operation and may preferentially perform specific operations, when specific operations are requested within the block copy operation period. Further, after specific operations are completed, the temporarily stopped block copy operation is resumed.

As described above, exemplary semiconductor memory device 100 can perform specific operations in addition to the read and write operations within the block copy operation period, such that the latency time for specific operations in addition to the read and write operations can be reduced.

In accordance with the exemplary implementations of the present invention, it is possible to increase the overall operation speed of the circuit by reducing the latency time for the circuit operation.

Although the spirit of the present invention was described in detail with reference to the preferred exemplary implementations, it should be understood that the preferred exemplary implementations are provided to explain, but do not limit the spirit of the present invention. Further, it can be understood that various forms of substitutions, modifications and alterations may be made by those skilled in the art without departing from the spirit of the prevent invention.

What is claimed is:

1. A method of operating a semiconductor memory having a plurality of memory blocks, comprising:
performing a block copy operation in response to a request of a block copy operation; and
stopping the block copy operation in response to a request of a specific operation while the block copy operation is performed.

2. The method of claim 1, further comprising:
storing a memory information related to a progression state of the block copy operation; and
performing specific operation according to a specific operation signal.

3. The method of claim 1, wherein each of the plurality of memory blocks includes a plurality of pages.

4. The method of claim 3, wherein the memory information includes a page address of a page that the block copy operation is completed.

5. The method of claim 3, wherein the memory information includes a page address of a page that the block copy operation is temporarily stopped.

6. The method of claim 2, further comprising:
resuming the block copy operation referring to the memory information after the performing specific operation.

7. The method of claim 2, wherein the specific operation signal is for requesting specific operation except for the block copy operation.

8. The method of claim 1, wherein the specific operation includes a merge operation, a read operation and a write operation.

9. A method of operating a semiconductor memory having a plurality of memory blocks comprising:
performing a block copy operation which copies a data stored in a first memory block to a second memory block;
stopping the block copy operation if a specific operation is requested while the block copy operation is performed; and
performing the specific operation.

10. The method of claim 9, further comprising:
resuming the block copy operation after the performing specific operation if the specific operation is performed in a third memory block.

11. The method of claim 10, further comprising:
storing a memory information related to a progression state of the block copy operation.

12. The method of claim 11, wherein each of the plurality of memory blocks includes a plurality of pages.

13. The method of claim 12, wherein the memory information includes a page address of a page that the block copy operation is completed.

14. The method of claim 12, wherein the memory information includes a page address of the memory block which is the block copy operation is temporarily stopped.

15. The method of claim 12, wherein the memory information includes a page address of a page that the block copy operation is temporarily stopped.

16. The method of claim 9, further comprising:
not resuming the block copy operation after the performing specific operation if the specific operation is performed in the first memory block or the second memory block.

17. A semiconductor system, comprising:
a host controller configured to transmit a block copy operation signal and a specific operation signal to a semiconductor memory device; and
the semiconductor memory device configured to performs a block copy operation in response to the block copy operation signal and a specific operation in response to the specific operation signal from the host controller,
wherein the semiconductor memory device, comprises:
a plurality of memory blocks configured to store data according to the block copy operation and the specific operation; and
a memory controller configured to:
perform the block copy operation in response to the block copy operation signal from the host controller; and
stop the block copy operation in response to the specific operation signal from the host controller while the block copy operation is performed.

18. The semiconductor system of claim 17, wherein the memory controller includes a buffer memory storing memory information related to a progression state of the block copy operation.

19. The semiconductor system of claim 18, wherein the memory controller stores memory information related to a progression state of the block copy operation to the buffer memory; performs the specific operation according to a specific operation signal; and resumes the block copy operation referring to the memory information after the specific operation is performed.

20. The semiconductor system of claim 17, wherein the memory controller does not resume the block copy operation after the specific operation is performed if the specific operation is performed in the same memory block as the block copy operation.
